(19) United States
(12) Patent Application Publication
(10) Pub. No.: US 2025/0259045 A1
(43) Pub. Date: Aug. 14, 2025

(54) SYSTEMS AND METHODS FOR RESPONDING TO LATENCY IN OUTPUT FROM A GENERATIVE MODEL

(71) Applicant: Shopify Inc., Ottawa (CA)

(72) Inventors: Ray Jayatunga, Toronto (CA); Ates Göral, Toronto (CA)

(21) Appl. No.: 18/436,474

(22) Filed: Feb. 8, 2024

(51) Int. Cl. G06N 3/0475

(52) U.S. Cl. CPC G06N 3/0475

(57) ABSTRACT

A generative model, e.g. a large language model (LLM), may be accessed by users over a network. A user might experience latency in the response from the generative model. To address the technical problem of latency, in some embodiments, the latency of the response from a first generative model is measured. If the latency falls within a particular range, then a switch to a second generative model is performed. In some embodiments, if the first generative model is not yet finished providing the response, then the partially-completed response from the first generative model is not deleted. Instead, the second generative model provides the remaining portion of the response so that the switch appears transparent and seamless to the user, and does not require restarting the generation process, thereby avoiding or mitigating the loss of already generated output and hence saving computer resources.

### FIELD

The present application relates to generative models that utilize machine learning, such as large language models (LLMs), and more particularly to responding to latency in the output from such models.

### BACKGROUND

In machine learning, a generative model is a model that utilizes machine learning to generate content, such as text or images, e.g. in response to an input prompt. A generative model may sometimes be referred to as generative artificial intelligence (AI). An example of a generative model is a generative language model, such as a large language model (LLM). An LLM generates language, typically in the form of text in response to an input prompt. An LLM may utilize a large neural network to determine probabilities for a next token of a sequence of text conditional on previous or historical tokens in the sequence of text.

### SUMMARY

In many scenarios, a generative model, e.g. an LLM, is not stored on a user's local computer or platform, but instead is accessed by users over a network. For example, the generative model may be part of a software-as-a-service (SaaS) system and accessed by a user's local computing device over the Internet, e.g. using an application programming interface (API). The generative model may serve many different users in parallel. When accessing the generative model, a user might sometimes experience latency in the response output from the generative model. For example, the response may be streamed to the user's computing device over the network but experience latency during that streaming. In some cases, the latency of the response might cause the response to completely fail, e.g. time out mid-response. A non-exhaustive list of reasons that may cause latency include: delays in the network or loss of network connection; and/or the generative model overloaded by a high volume of user requests (e.g. overload of the server hosting or interfacing with the generative model); and/or performance issues with the generative model itself, e.g. due to maintenance, software, and/or hardware issues with the generative model; and/or API or infrastructure errors, such as issues with load balancers, data pipelines, and other middleware; etc. Latency may lead to significant response time delays and/or lead to potential bottlenecks and/or require restarting the generation process, which may result in the loss of already generated output and hence waste computer resources like token limits and/or computational power.

To address the technical problem of latency explained above, in some embodiments, the latency of the response from a first generative model is measured. If the latency falls within a particular range, then a switch to a second generative model is performed. In some embodiments, if the first generative model is not yet finished providing a response at the time of switching (i.e. the response is only partially-completed), then the partially-completed response provided thus far from the first generative model is not deleted. Instead, the second generative model provides the remaining portion of the response so that the switch from the first generative model to the second generative model appears transparent and seamless to the user, and does not require restarting the generation process, thereby avoiding or mitigating the loss of already generated output and hence saving computer resources like token limits and/or computational power.

One example is as follows, assuming the generative model is an LLM. A first input prompt is transmitted to a first LLM, e.g. using an API. The first input prompt may be or represent text, e.g. it may be a question such as “How should I start my blog post?”. The first LLM receives the input prompt and begins generating a response and streaming it to the user. However, during the streaming of the response latency may occur. For example, the first part of the response (e.g. “The hallmark of a successful blog post is to start”) may be received by the user's computer promptly for display, but a subsequent portion of the response may become delayed or possibly never even generated or never even transmitted from the first LLM or received by the user's computer due to latency. To address this issue, the latency of the symbols (e.g. tokens or words or Unicode characters, etc.) received from the first LLM may be measured. For example, the number of tokens per unit of time may be measured. If the latency falls within a particular range (e.g. the average tokens per second measured over a rolling time window drops below a certain threshold), then a switch may be made to a second LLM. The second LLM may be a different LLM from the first LLM, or the first LLM and the second LLM may be the same model, e.g. different hardware instances of the same model accessed via different endpoints. A prompt may be sent to the second LLM that is based on at least some of the symbols received from the first LLM. This may provide for switching that attempts to be seamless and transparent to the user and does not require restarting the generation process. For example, when the switch occurs, perhaps only a partially-completed response to the input prompt to the first LLM has been received. For example, perhaps only the following text of the response has been received: “The hallmark of a successful blog post is to start”. This text may be included in the input prompt to the second LLM. For example, the input prompt to the second LLM may be “Finish the response: How should I start my blog post? The hallmark of a successful blog post is to start”. A response is provided by the second LLM. For example, the response may be: “off with a personal story that connects with the reader”. The response from the second LLM may be displayed as the remaining portion of the partially-completed response received from the first LLM.

In one aspect, there is provided a computer-implemented method. The method may include transmitting a first input prompt to a first generative model. The method may further include receiving first symbols output from the first generative model responsive to the first input prompt. The method may further include measuring a latency associated with receiving the first symbols from the first generative model. Responsive to the latency being within a particular range, the method may further include transmitting a second input prompt to a second generative model. In some embodiments, the second input prompt is based on at least some of the first symbols received from the first generative model. The method may further include receiving second symbols output from the second generative model responsive to the second input prompt. The method may further include providing output based on the first symbols and the second symbols. For example, the output might be the first symbols followed by the second symbols. For example, if the symbols are text or representative of text, such as Unicode characters or tokens that can be mapped to text, then the output may be text based on the first symbols followed by text based on the second symbols, where the text based on the second symbols is adjacent to the text based on the first symbols.

In some embodiments, the first generative model may be a first LLM, and the second generative model may be a second LLM.

In some embodiments, only a partially-completed response to the first input prompt may have been received from the first generative model when the second input prompt is transmitted to the second generative model. The partially-completed response may be based on the first symbols. In some embodiments, a remaining portion of the response to the first input prompt is based on the second symbols output from the second generative model. In some embodiments, providing output based on the first symbols and the second symbols may include: providing, for output on a display of a device, the partially-completed response based on the first symbols; and responsive to receiving at least a portion of the second symbols, providing for output on the display, the remaining portion of the response based on the second symbols. In some embodiments, the remaining portion may be provided for output adjacent to and/or following the partially-completed response.

In some embodiments, the latency may be measured based on an amount of time to receive a symbol. In some embodiments, measuring the latency may include measuring at least one of: symbols received per unit of time; time taken to receive the first symbols; time to receive a symbol; or time to first symbol.

In some embodiments, the second input prompt may be further based on the first input prompt. In some embodiments, the second input prompt may be further based on content corresponding to an exchange between a device and the first generative model prior to the first input prompt. In some embodiments, the content may provide a summary of the exchange. In some embodiments, the method may include providing, to the first generative model or to a third generative model, an input prompt comprising the exchange, and in response receiving the summary of the exchange. In some embodiments, the second input prompt may be based on both the summary of the exchange and input prompts and/or symbols transmitted between the device and the first generative model subsequent to the exchange up until the second input prompt is generated.

In some embodiments, the first generative model and the second generative model are at least one of: a same model; different instances of the same model; a same architecture; fine-tuned in a same way; or have a same configuration setting. In some embodiments, the first generative model may be hosted by a particular software-as-a-service (SaaS) provider and the second generative model might or might not be hosted by that particular SaaS provider.

In some embodiments, prior to transmitting the second input prompt to the second generative model, the method may include transmitting a prompt to the second generative model and measuring the latency associated with receiving symbols from the second generative model in response to the prompt.

In some embodiments, subsequent to transmitting the second input prompt to the second generative model, the method may include receiving additional symbols from the first generative model, where the additional symbols are received subsequent to the first symbols but still responsive to the first input prompt. The method may further include storing the additional symbols in memory. The method may further include outputting at least some of the additional symbols for display instead of at least some of the second symbols.

A system is also disclosed that is configured to perform the methods disclosed herein. For example, the system may include at least one processor and a memory storing processor-executable instructions that, when executed, cause the at least one processor to perform any of the methods disclosed herein, e.g. the at least one processing unit may perform steps such as: transmitting a first input prompt to a first generative model; receiving first symbols output from the first generative model responsive to the first input prompt; measuring a latency associated with receiving the first symbols from the first generative model; responsive to the latency being within a particular range, transmitting a second input prompt to a second generative model, the second input prompt based on at least some of the first symbols received from the first generative model; receiving second symbols output from the second generative model responsive to the second input prompt; and providing output based on the first symbols and the second symbols.

In another aspect, there is provided a computer readable medium having stored thereon computer-executable instructions that, when executed by a computer, cause the computer to perform any of the methods disclosed herein. The computer readable medium may be non-transitory.

### BRIEF DESCRIPTION OF THE DRAWINGS

Embodiments will be described, by way of example only, with reference to the accompanying figures wherein:

FIG. 1A is a simplified block diagram of an example simplified convolutional neural network;

FIG. 1B is a simplified block diagram of an example transformer neural network;

FIG. 2 is a block diagram of an example computing system;

FIG. 3 illustrates a system for responding to latency in output from a generative model, according to some embodiments;

FIG. 4 illustrates an example of an exchange between a user device and a first generative model;

FIGS. 5 to 7 illustrate examples of streaming a response from the first generative model;

FIG. 8 illustrates a method performed by a computing system, according to some embodiments; and

FIGS. 9 to 12 illustrate examples corresponding to steps of the method of FIG. 8.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

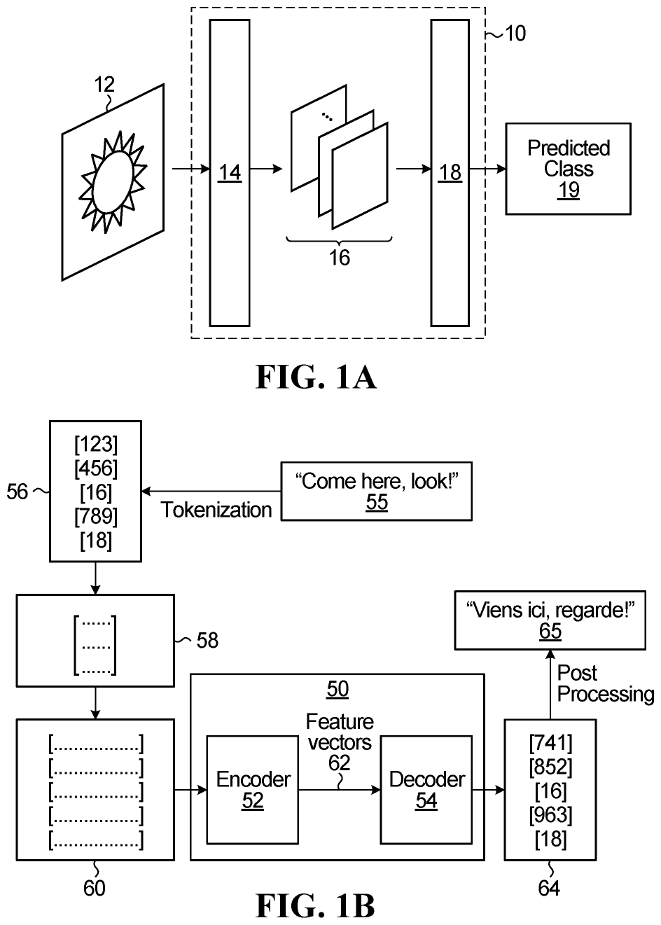

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

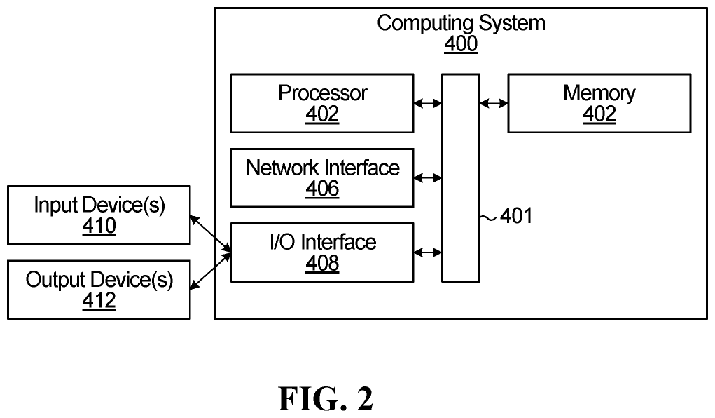

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

Addressing Latency in Output from a Generative Model

The LLM discussed above is an example of a generative model. A generative model is a model that utilizes machine learning to generate content, e.g. in response to an input prompt. A generative model does not need to be limited to a generative language model such as an LLM. For example, a generative model might additionally or instead generate other content, e.g. an image or multimedia that includes more than just language.

In many scenarios, a generative model, e.g. an LLM, is not stored on a user's local computer or platform, but instead is accessed by users over a network. For example, the generative model may be part of a software-as-a-service (SaaS) system and accessed by a user's local computing device over the Internet, e.g. using an API. For example, the generative model may be the remote LLM discussed above that is hosted by a remote system (e.g., a cloud-based system) and that is accessed via the API call discussed above. The generative model (e.g. LLM) may serve many different users in parallel.

When accessing a generative model, a user might sometimes experience latency in the response output from the generative model. For example, the response may be streamed to the user's computing device over the network but experience latency during that streaming. In some cases, the latency of the response might cause the response to completely fail, e.g. time out mid-response. To address the latency, in some embodiments, the latency of the response from a first generative model is measured. If the latency falls within a particular range, then a switch to a second generative model is performed. The second generative model may be a different generative model from the first generative model, or the first generative model and the second generative model may be the same model, e.g. different hardware instances of the same model. The switch may involve switching to a different generative model endpoint.

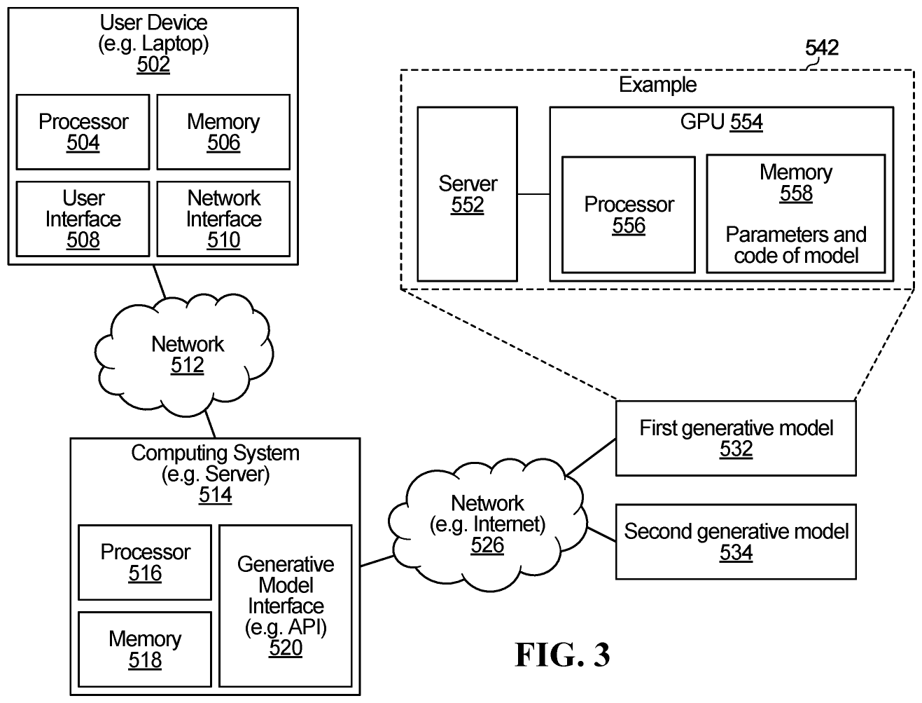

FIG. 3 illustrates a system for responding to latency in output from a generative model, according to some embodiments. The system includes a user device 502. Only one user device is illustrated, but the system may include multiple user devices, e.g. all accessing a generative model in parallel. The user device 502 is a device used by a user to communicate with a generative model. For example, the user device 502 may be a personal computer, or laptop, or desktop computer, or mobile device such as a tablet or smartphone, or an augmented reality (AR) device, etc., depending upon the implementation. The user device 502 includes a processor 504, memory 506, user interface 508, and network interface 510. The processor 504 controls the operations of the user device 502. The processor 504 may be implemented by one or more processors that execute instructions stored in the memory 506. Alternatively, some or all of the processor 504 may be implemented using dedicated circuitry, such as an application specific integrated circuit (ASIC), a graphics processing unit (GPU), or a programmed field programmable gate array (FPGA). The memory 506 stores information (e.g. content and/or instructions, etc.). The user interface 508 allows the user (e.g. a human) to provide input to and receive output from the user device 502. For example, the user interface 508 may include a display (which may be a touch screen), and/or a keyboard, and/or a mouse, etc. The network interface 510 interfaces with a network 512 to perform communication (transmit/receive) over that network 512. The structure of the network interface 510 will depend on how the user device 502 interfaces with the network. For example, if the user device 502 is a smartphone or tablet, the user device 502 may comprise a transmitter/receiver with an antenna to send and receive wireless transmissions over the network 512. If the user device 502 is a personal computer connected to the network 512 with a network cable, the network interface 510 may comprise a network interface card (NIC), and/or a computer port (e.g. a physical outlet to which a plug or cable connects), and/or a network socket, etc.

The system of FIG. 3 further includes a computing system 514 that is an intermediary between the user device 502 and one or more generative models. For example, the computing system 514 may send prompts to a generative model via an API on behalf of the user device 502 and transmit responses from the generative model to the user device 502. In the illustrated embodiment, the user device 502 and computing system 514 communicate over network 512. Network 512 might be, for example, the Internet or an Intranet or local network. The computing system 514 may be (or may be part of) a computing platform that is accessible to the user device 502 and that provides services to the user device 502. For example, the computing system 514 might be a server that is part of the computing platform serving the user device 502.

The computing system 514 includes a processor 516, memory 518, and a computing interface (e.g. an API or multiple APIs) that is used to access one or more generative models. The computing interface is referred to as generative model interface 520. The processor 516 controls the operations of the computing system 514. The processor 516 may be implemented by one or more processors that execute instructions stored in the memory 518. Alternatively, some or all of the processor 516 may be implemented using dedicated circuitry, such as an ASIC, GPU, or FPGA. The memory 518 stores information (e.g. content and/or instructions, etc.). The generative model interface 520 interfaces with one or more generative models, e.g. by sending prompts over a network 526 to a generative model and receiving responses back from the generative model. For example, the generative model interface 520 may be or include an API. The API may include an API key to enable the computing system 514 to be identified by the system hosting the generative model. The API call may include an identification of the generative model to be accessed. The API call may include one or more configuration settings that adjust the output generated by the generative model. Examples of configuration settings may include settings that control the length, style, and/or content output from the generative model, e.g. maximum or minimum number of tokens, and/or randomness of the output (e.g. temperature), and/or a stopping criteria, and/or a generation seed (such that if the same seed is used, the model returns the same output), etc. The temperature parameter, minimum length of the output and/or maximum length of the output, the frequency penalty parameter, and the “best of” parameter discussed earlier are examples of configuration settings. In some embodiments, the generative model interface 520 may actually comprise a plurality of different interfaces, e.g. a different API for each generative model, where one API is used to send prompts and configuration settings to a first genitive model and receive responses from that first generative model, and where a different API is used to send prompts and configuration settings to a second generative model and receive responses from that second generative model. In an alternative embodiment, the generative model interface 520 may comprise a single API that can interface with multiple generative models, e.g. if the multiple generative models are the same (e.g. different instances of the same model accessible via different endpoints). In some embodiments, the generative model interface 520 need not be or include an API, e.g. it may communicate with a generative model via messages sent to/received from the generative model without use of an API, e.g. network messages sent over the Internet. The generative model interface 520 may be implemented by the processor 516, e.g. by the processor 516 executing instructions that cause the processor 516 to perform the functions of the generative model interface 520.

Although not illustrated, the computing system 514 also includes one or more network interfaces for communicating over network 512 and network 526. A network interface may comprise a network interface card (NIC), and/or a computer port (e.g. a physical outlet to which a plug or cable connects), and/or a network socket, etc. The generative model interface 520 might be considered part of the network interface that interfaces with network 526, depending upon the implementation.

In a variation of FIG. 3 not illustrated, the computing system 514 does not need to exist or it may be one and the same as the user device 502. In those scenarios, the user device 502 interfaces directly with one or more generative models over network 526. The generative model interface 520 would be part of user device 502. The remaining explanation assumes the scenario actually illustrated in FIG. 3, i.e. a computing system 514 separate from the user device 502 and acting as the intermediary. However, it will be appreciated that in all scenarios described herein the operations performed by the computing system 514 could alternatively be performed by the user device 502 in the absence of the separate computing system 514 and/or if the computing system 514 were considered part of or the same as the user device 502, depending upon the implementation.

The system of FIG. 3 further includes a first generative model 532 and a second generative model 534, both accessible to the computing system 514 over network 526. For example, the network 526 may be the Internet, the first generative model 532 may be at a first endpoint accessible via the Internet, and the second generative model 534 may be at a second endpoint accessible via the Internet. Although the two generative models are labelled “first” generative model 532 and “second” generative model 534, this is for ease of notation. The two models might actually be the same model, e.g. the same model parameters and code, just two different instances. For example, one may be a replica of the other, each operating in parallel, e.g. on two different computers (e.g. servers) and/or on two different specialized processing circuits (e.g. two different graphical processing units (GPUs)). For example, both the first generative model 532 and second generative model 534 might both be GPT-4™, just different hardware instances, e.g. separately executing in parallel on different hardware and/or on different computers and/or on different specialized processing circuits (e.g. different GPUs) and/or at two different network locations. In some embodiments, it might instead be the case that the first generative model 532 and second generative model 534 are a same single instance of a model executed by a same device (e.g. a single hardware instance), but effectively presented as two different generative model instances, e.g. via two different APIs. For example, two different computing devices (e.g. servers) possibly at different network locations may each act as a distinct endpoint for receiving requests to access a generative model. Each computing device may receive and handle their own requests and keep their own states and/or sessions for users, but ultimately interface with a same backend processing unit that executes a generative model in response to prompts received from either computing device. The two models would actually be two different endpoints for accessing a model. In another variation, the first generative model 532 and second generative model 534 might both have the same architecture and/or class and/or trained or fine-tuned in the same way, but might not be the exact same or might not be replicas or might not be different instances. For example, the first genitive model 532 and the second generative model 534 may have slightly different code and/or model parameters. In another variation, the first generative model 532 and the second generative model 534 may be different models, e.g. different model architectures. For example, the first generative model 532 may be GPT and the second generative model 534 may be BERT.

In some embodiments, the first generative model 532 and the second generative model 534 may each be provided by a software-as-a-service (SaaS) provider, possibly the same SaaS provider. In some embodiments, the first generative model 532 and the second generative model 534 may be provided by different SasS providers, e.g. the first generative model 532 might be provided by Open AI™ and the second generative model 534 might be provided by Microsoft Azure™. In some embodiments, one of the generative models may be provided by a SaaS provider and the other generative model may be hosted locally. For example, the first generative model 532 may be hosted by a SaaS provider and the second generative model 534 may be hosted by the same platform that includes computing system 514, or vice versa.

Stippled box 542 in FIG. 3 shows an example of how the first generative model 532 may be implemented. The generative model may be executed by a specialized processing unit, e.g. one designed to accelerate computer operations of a generative model through parallelization of operations, which may allow for faster execution of the generative model compared to a more general-purpose processing unit. For example, the specialized processing unit may be a GPU or a tensor processing unit (TPU) or a neural processing unit (NPU) or a hardware accelerator. In the example in stippled box 542 of FIG. 3, there is a specialized processing unit in the form of GPU 554 that includes one or more processing circuits (illustrated as processor 556) and memory 558. The code and parameters of the first generative model 532 are stored in the memory 558 and executed by the processor 556. The specialized processing unit may be paired with a general-purpose processing unit, e.g. a computer, central processing unit (CPU), and/or other computing device such as a server. The general-purpose processing unit may handle and/or prioritize requests originating from different users, provide prompts to the model, receive responses, and formulate and provide those responses to the users. For example, the general-purpose processing unit may receive an API call from the generative model interface 520, as well as from other systems wanting to access the generative model, and provide API responses. In the example in stippled box 542 of FIG. 3, the general-purpose processing unit is in the form of a server 552.

The structure illustrated in stippled box 542 is just an example. Alternative implementations are possible. For example, in an alternative implementation the first generative model 532 may be executed on a single computing device, e.g. a powerful computer that both receives the API calls, prioritizes and handles requests, executes the model, and returns responses.

The second generative model 534 may have the same example structure illustrated in stippled box 542, or a different structure. In general, the structure of the first generative model 532 and the second generative model 534 may be the same, equivalent, or different. If the first generative model 532 and the second generative model 534 are the same model, it might or might not be the case that the same server 552 is used for accessing both models, but there may be different hardware instances of the model, e.g. GPU 554 implementing one hardware instance of the model and a different GPU implementing a different hardware instance of the model. For example, the second generative model 534 may have the same structure as the first generative model 532 illustrated in stippled box 542, but instead of GPU 554, the second generative model 534 may be implemented and executed on a different GPU, i.e. a different hardware instance. The parameters and code may be exactly or substantially the same on both GPUs such that it is a same or equivalent model being executed on both GPUs. The server interfacing with the GPU of the second generative model 534 may be server 552, or it may be another computer device. The first generative model 532 and second generative model 534 may be at different network endpoints, e.g. different network locations.

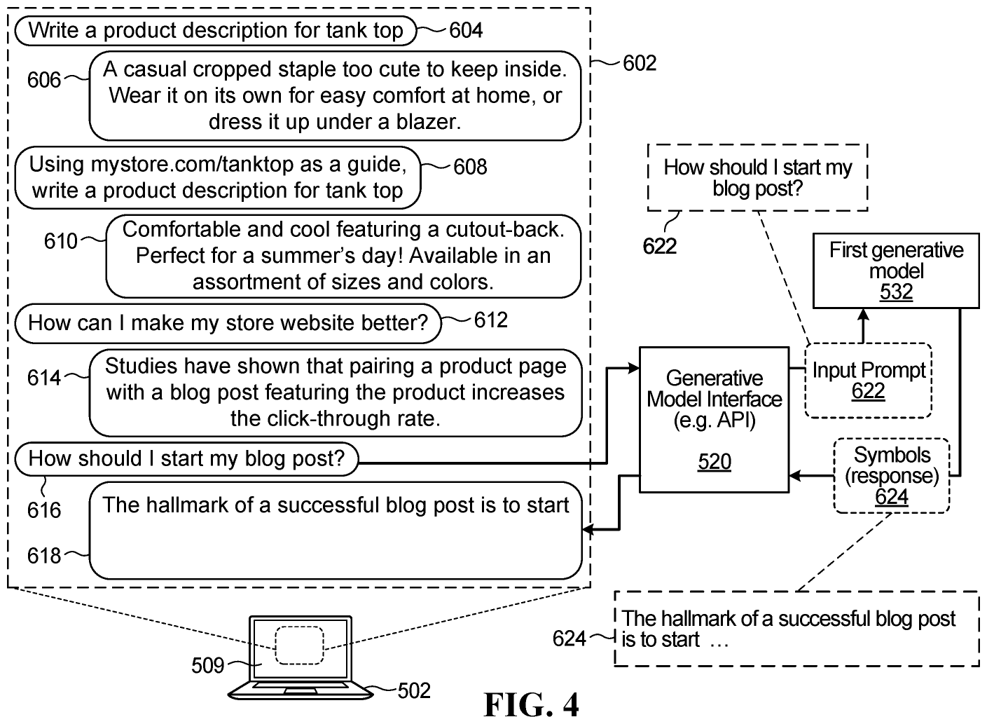

FIG. 4 illustrates an example of an exchange between user device 502 and the first generative model 532. In this example introduced and continued herein, it is assumed that a generative model is a generative language model, e.g. an LLM, that generates language in response to input prompts. However, as mentioned earlier, a generative model need not necessarily be a generative language model, e.g. it may generate images.

FIG. 4 illustrates the user device 502 as a laptop, but of course this is only an example. In the example, the user interface of the user device 502 includes a display 509, and a portion of that display 509 is illustrated in stippled box 602.

A user is using the user device 502 to have an exchange with the first generative model 532 in the form of a chat using a chat application accessed by the user device 502. The user begins by asking the first generative model 532 (via the chat application) for a product description for a tank top. The user uses the user interface 508 of the user device 502 to type in “Write a product description for tank top”, as shown at bubble 604. This text is forwarded to the first generative model 532 via generative model interface 520 and acts as an input prompt to the first generative model 532. For simplicity of illustration, many components of FIG. 3 are not illustrated again in FIG. 4, but they are present and used to forward prompts to and receive responses from the first generative model 532. The same remark applies to the remaining figures.

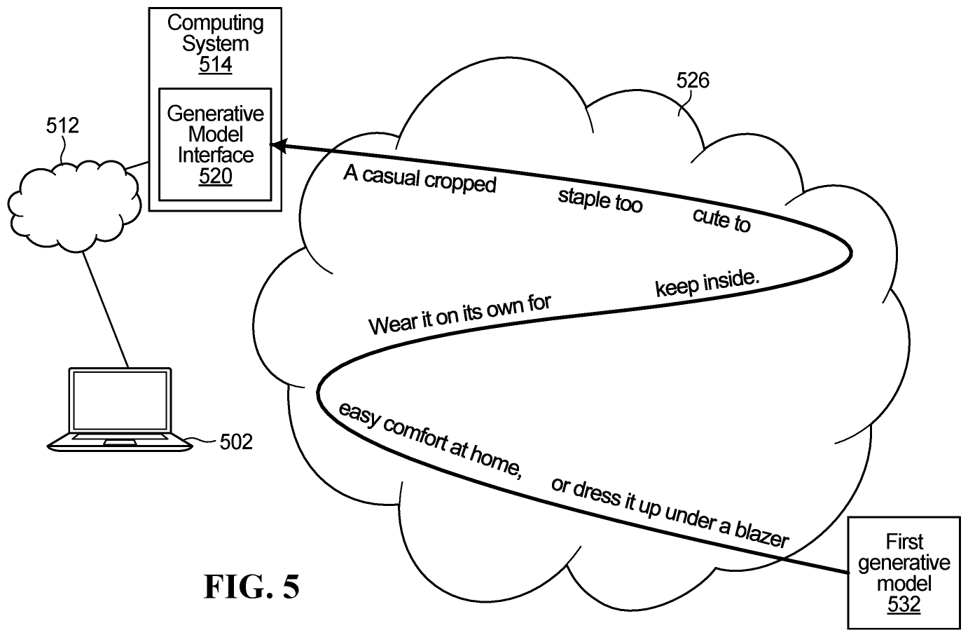

The first generative model 532 generates a response that is received by the user device 502 and displayed in bubble 606: “A casual cropped staple too cute to keep inside. Wear it on its own for easy comfort at home, or dress it up under a blazer.” This response is streamed for display on user device 502. For example, as shown in FIG. 5, the first generative model 532 outputs the response and it is streamed over network 526 (e.g. the Internet), possibly in the form of a response to an API call, and it is received by the generative model interface 520. The generative model interface 520 receives the response and forwards it to user device 502 for display.

The first generative model 532 generates the response by generating and outputting a plurality of symbols, where the response comprises or is based on the symbols. A “symbol”, as used herein, refers to a unit of output from a generative model. For example, a symbol may be a token, or a segment or chunk of text, or one or more pixels, or one or more characters, or a numerical representation of characters or text, such as American standard code for information interchange (ASCII) or Unicode characters, etc. A symbol may be before or after an output transformation. The actual composition of a symbol is implementation specific. For completeness a few examples are as follows. In one example, the first generative model 532 outputs a plurality of tokens that have been transformed by the first generative model 532 (e.g. by the post processing discussed earlier) to Unicode characters representing text. In another example, the first generative model 532 outputs tokens, where a token is a numerical representation corresponding to one or more characters, but that needs to be subsequently transformed to a numerical representation in Unicode or ASCII at computing system 514. In another example, if the generative model is not generating language but is instead generating an image, the symbols output may be or include one or more image pixel values.

If there is no latency (or an acceptable level of latency) the symbols are output and streamed at a steady rate, in some cases so promptly that (in the case of text) it may be available for output as fast as or faster than it can actually be read by a human. In such a situation, the text based on the symbols may be buffered (e.g. at computing system 514 and/or user device 502) and output at a rate that is about equal to (or a bit faster than) the average reading speed of a human.

Returning to FIG. 4, the symbols output from the first generative model 532 (i.e. the response) is transformed if/as needed to represent text (e.g. a transformation from token values to numerical representations of text, if necessary), and output for display as the response as shown in bubble 606. In the example, the user is not satisfied with the product description generated as the response. The user decides to provide the first generative model 532 with more information, e.g. shot-prompting via a one-shot prompt. In the example, the user provides a website for the tank top to provide more input/context for the first generative model 532. Specifically, in the example, the user uses the user interface 508 of the user device 502 to type in: “Using mystore.com/tanktop as a guide, write a product description for tank top”, as shown at bubble 608. This text is forwarded to the first generative model 532 via generative model interface 520 and acts as a new input prompt to the first generative model 532. The first generative model 532 generates a response that is again streamed as explained in relation to FIG. 5, and ultimately received by the user device 502 and displayed in bubble 610: “Comfortable and cool featuring a cutout-back. Perfect for a summer's day! Available in an assortment of sizes and colors.” The user then changes topics and ask the first generative model 532 “How can I make my store website better?”, as shown in bubble 612. This text is forwarded to the first generative model 532 via generative model interface 520 and acts as an input prompt to the first generative model 532. The first generative model 532 generates a response that is received by the user device 502 and displayed in bubble 614: “Studies have shown that pairing a product page with a blog post featuring the product increases the click-through rate.” The user uses the user interface 508 of the user device 502 to type in a new question in reply: “How should I start my blog post?”, as shown at bubble 616. This text is forwarded to the first generative model 532 via generative model interface 520 and acts as an input prompt to the first generative model 532.

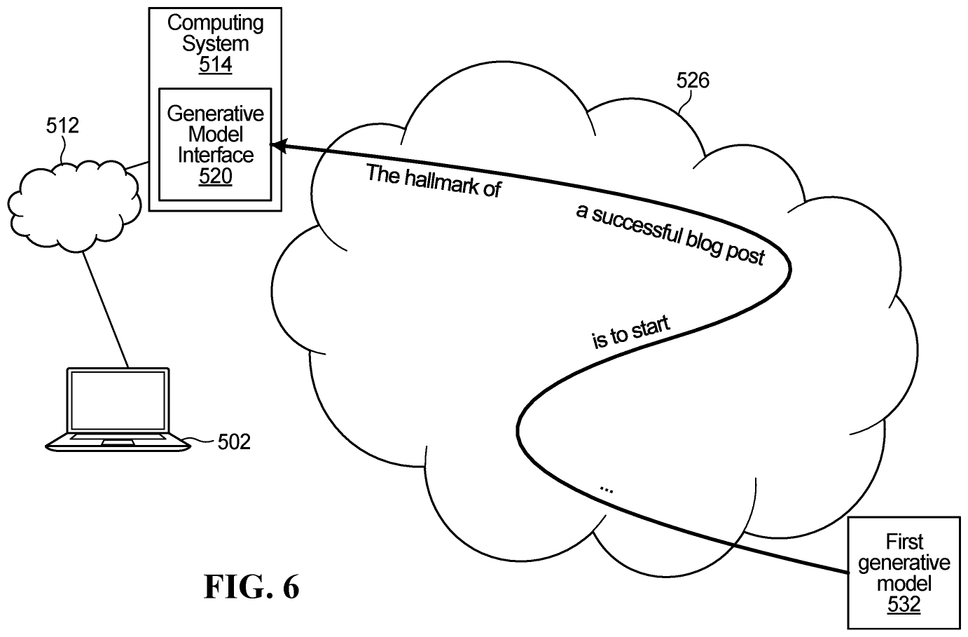

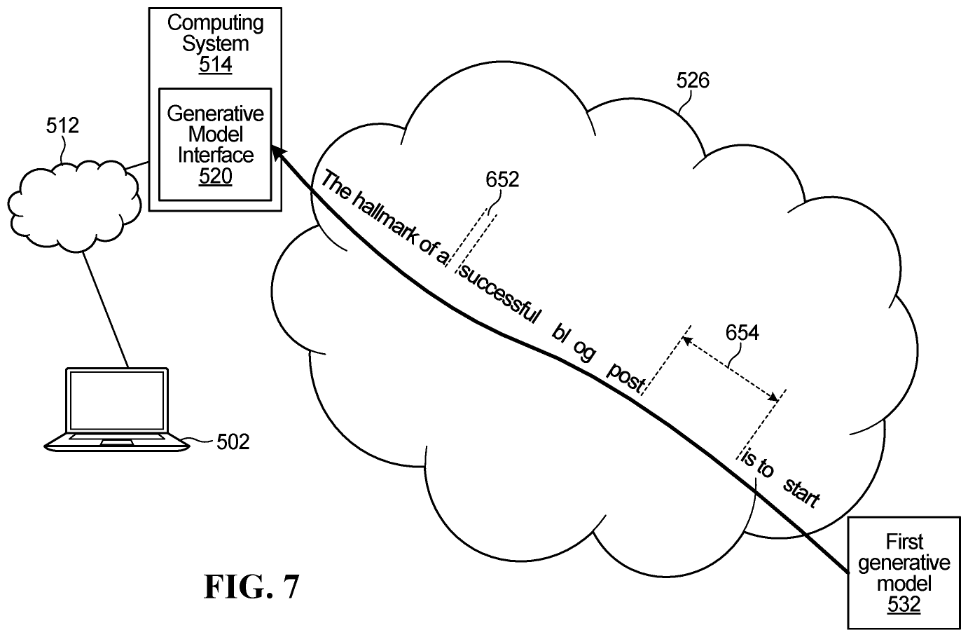

The input prompt “How should I start my blog post?” is specifically illustrated in FIG. 4 as input prompt 622. The first generative model 532 begins providing a response, which is output as a plurality of symbols and streamed in the manner explained in relation to FIG. 5. However, latency occurs in association with receiving the symbols, e.g. as shown in FIG. 6. In the example in FIG. 6, the symbols forming the basis of the partially-completed response “The hallmark of a successful blog post is to start” are received promptly at the generative model interface 520 and forwarded for display on the user device 502. However, in the example in FIG. 6 the first generative model 532 experiences a delay in outputting any further symbols of the response, which causes latency. Alternatively, the delay might occur in the network 526. In the example in FIG. 6, the response times out. In a variation illustrated in FIG. 7, the symbols continue to be output from the first generative model 532 and streamed to the generative model interface 520, but due to either a delay caused by the first generative model 532 or a delay in network 526 (or perhaps both) the time between receipt of adjacent symbols becomes farther apart. For example, the time between “a” and “successful” is within an acceptable range, as shown at 652, but the time between “post” and “is” is not within an acceptable range, as shown at 654. For example, the delay between “post” and “is” may be such that the user notices, e.g. the user is reading the response as it is being streamed and needs to stop and wait for the next word “is”. FIGS. 6 and 7 are only two examples of latency associated with receiving the symbols. A non-exhaustive list of reasons for latency may include:
A delay in a network (e.g. in network 526).
A loss of a network connection (e.g. loss of the network connection between computing system 514 and first generative model 532).
The first generative model 532 overloaded by a high volume of user requests, thereby causing a delay in the output from the first generative model 532.
Overload of a server (or other computing device) hosting or interfacing with the first generative model 532 (e.g. the server 552 in the example in box 542 of FIG. 3 becoming overloaded, such as from too many requests).
Performance issues with the first generative model 532 itself that result in a delay in output from the first generative model 532, e.g. due to maintenance, software, and/or hardware issues with the first generative model 532.
API or infrastructure errors, such as issues with load balancers, data pipelines, and other middleware (e.g. an API of the generative model interface 520 experiencing an error thereby causing the generative model interface 520 to experience latency in receiving the symbols output from the first generative model 532.

Note that in the examples presented herein there is assumed to be no problematic latency in the connection between the computing system 514 and the user device 502, e.g. over network 512. As mentioned earlier, there might not even exist both a computing system 514 and a separate user device 502, e.g. there might only be a user device 502 that includes generative model interface 520, in which case any steps described herein as being performed by the computing system 514 would be performed by the user device 502. However, in general, if there is a computing system 514 acting as an intermediary between the user device 502 and the first generative model 532, as illustrated, then latency might also or instead exist in network 512.

The latency described herein may lead to significant response time delays and/or lead to potential bottlenecks and/or require restarting the generation process. This results in problems in the computer system itself, e.g. the waste of computer resources in having to wait for the symbols or having to restart the generation process, e.g. by the generative model interface 520 needing to resend the input prompt. This has a material impact on the performance of the computer because a generative model is a precious computing resource and so in many situations there is a limit (e.g. on the computing system 514 and/or on the user device 502) limiting use of the first generative model 532. For example, the limit may be a token limit and/or a limit on how many prompts can be sent to the first generative model 532, etc. The restarting of the generation process, such as by resending the input prompt, uses up the valuable limited resource. In addition, the latency also impacts the machine-user interaction. The streaming of the response may be delayed such that it is slower than the user takes to view (e.g. read) that response. The user is therefore frustrated. If the latency is such that the response times out and needs to be restarted, then the computer has the problem of how to modify the user interface of the user device 502. For example, as shown at FIG. 4 in bubble 618, the first portion of the response is already displayed on the user interface for the user to read. Should the computer automatically delete it and confuse the user? If the computer automatically deletes the first portion of the response and completely restarts it, e.g. by resending the same input prompt to the first generative model 532, the regenerated response might follow a different probabilistic path and generate a very different reply that does not even start the same way as the deleted response, which may frustrate the user if the user had been satisfied with the part of the previous response that they were able to see and that had just been deleted. The computer is not equipped to handle the fallout from the latency, such as the problems discussed above.

In some embodiments, to address the problems of latency, e.g. to address some or all of those problems discussed immediately above, a switch to the second generative model 534 may be performed in the manner described herein.

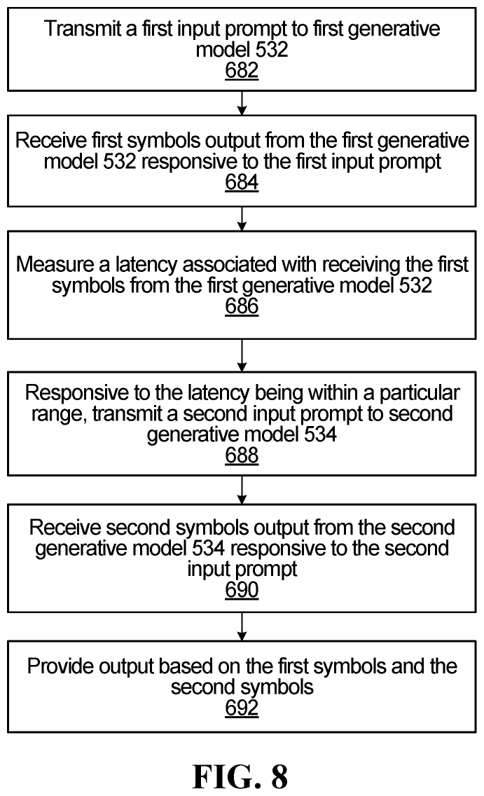

FIG. 8 illustrates a method performed by computing system 514, according to some embodiments.

At step 682, the computing system 514 transmits a first input prompt to first generative model 532. The label “first” input prompt is simply notation used to distinguish from a later (“second”) input prompt. It does not necessarily mean it was the first input prompt sent to first generative model 532, e.g. it is not necessarily the first input prompt of the session, although it could be. Input prompt 622 of FIG. 4 (“How should I start my blog post?”) is an example of the first input prompt of step 682 of FIG. 8. The first input prompt in step 682 may be the prompt directly preceding the delayed output that causes the latency issue.

At step 684, the computing system 514 receives first symbols output from the first generative model 532 responsive to the first input prompt. The label “first” symbols is simply notation used to distinguish from later (“second”) symbols output from the second generative model 534. It does not necessarily mean they are literally the first symbols output from the first generative model 532, although they could be. The symbols 624 of FIG. 4 output from the first generative model 532 (that form the basis of the partially-completed response “The hallmark of a successful blog post is to start”) is an example of the first symbols of step 684 of FIG. 8.

At step 686, the computing system 514 measures a latency associated with receiving the first symbols from the first generative model. In some embodiments, the latency may be measured based on an amount of time to receive a symbol. In some embodiments, measuring the latency may include measuring at least one of: symbols received per unit of time; time taken to receive the first symbols; time to receive a symbol; or time to first symbol. In one example, measuring the latency comprises measuring the average number of symbols received per unit of time (e.g. number of symbols per second), perhaps measured over a rolling time window.

In the method, it is assumed that the measured latency is within a particular range that is unacceptable, e.g. exceeding a maximum user-perceived latency. For example, if the latency is measured by measuring symbols received per unit of time, it may be that the number of symbols received over a particular time window is too few. For example, the average symbols received per second measured over a rolling time window has dropped below a certain threshold. As another example, if the latency is measured by measuring time to receive a first or next symbol, it may be that the time exceeds a particular threshold. As another example, if the latency is measured by measuring how long it takes to receive all of the first symbols, it may be determined that the time it took to receive all of the first symbols exceeds a threshold.

At step 688, responsive to the latency being within the particular range, the computing device 514 transmits a different second input prompt to second generative model 534. The switch to the second generative model 534 is performed so that the exchange between the user and a generative model can continue while avoiding the latency associated with the first generative model 532. As explained above, that latency might be due to the first generative model itself (e.g. the first generative model 532 is overloaded with requests or has performance issues), or due to a network connection between the computing system 514 and the system hosting the first generative model 532, or some sort of API or infrastructure or middleware error associated with the first generative model 532, etc. The computing system 514 might not know the reason for the latency and does not need to investigate the reason. The computing system 514 instead uses its detection of latency as a trigger to switch to the second generative model 534.

In some embodiments, the second input prompt transmitted to the second generative model 534 may be based on at least some of the first symbols received from the first generative model 532. For example, the second input prompt may include or be some or all of the first symbols, or the second input prompt may include or be a summary obtained from some or all of the first symbols, or the second input prompt may include something related to the first symbols.

At step 690, the computing system 514 receives second symbols output from the second generative model 534 responsive to the second input prompt. At step 692, the computing system 514 provides output (e.g. for user device 502) based on the first symbols and the second symbols.

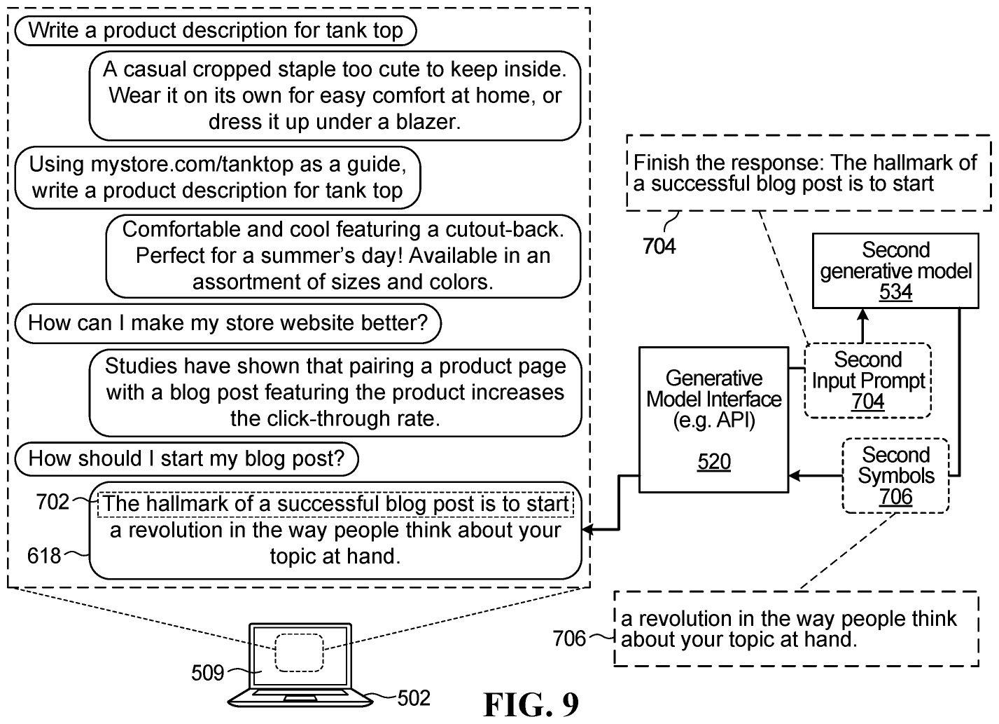

An example of steps 688 to 692 is illustrated in FIG. 9. The first symbols forming the basis of the partially-completed response “The hallmark of a successful blog post is to start” have been received from the first generative model 532 and output for display, as shown at 702. The latency associated with receiving these first symbols was measured and it was determined that the latency is within a particular range that is unacceptable, i.e. too delayed. In response, a second input prompt 704 is transmitted to the second generative model 534. The second input prompt 704 is based on at least some of the first symbols received from the first generative model 532. Specifically, in the example the second input prompt is “Finish the response: The hallmark of a successful blog post is to start”, i.e. it is a prompt that asks the second generative model 534 to finish the response partially-received from the first generative model 532. Second symbols 706 are output from the second generative model 534, which in the example form the basis of the text “a revolution in the way people think about your topic at hand”. The output shown in bubble 618 is based on the first symbols and the second symbols. Specifically, in this example, the output includes the partially-completed response of the first symbols (from the first generative model 532) and the remainder of the response provided by the second symbols 706 (from the second generative model 534).

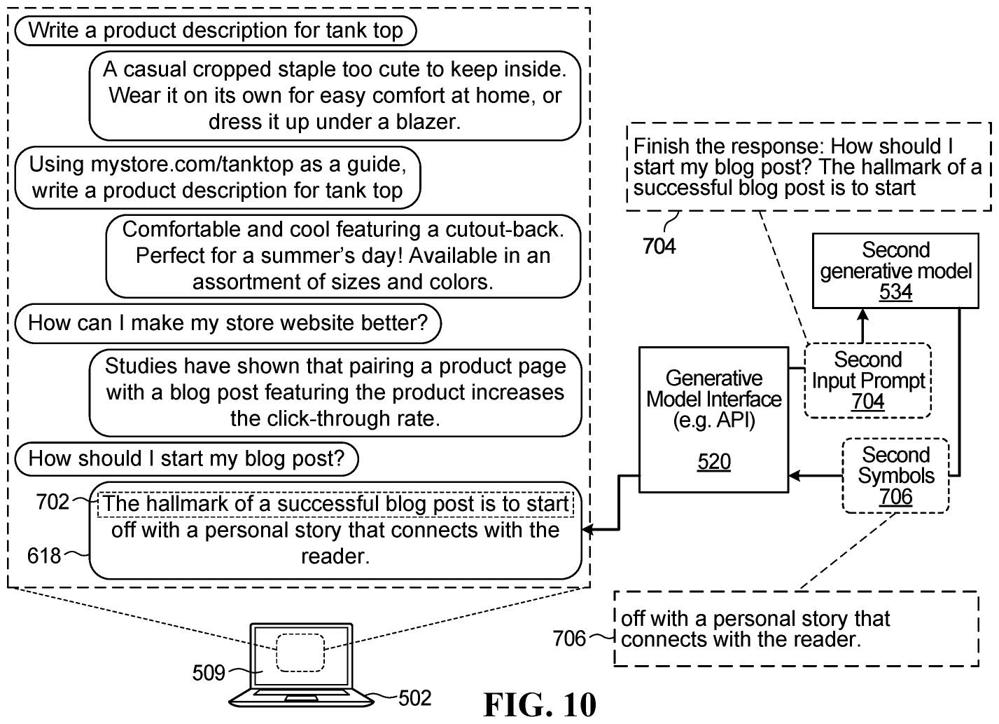

Providing a second input prompt that is only based on the first symbols received from the first generative model 532 might not provide enough context to provide a consistent or suitable response from the second generative model 534. Such is the case in the example in FIG. 9 in which the second generative model 534 returns “a revolution in the way people think about your topic at hand”. The second generative model 534 had no way to know in this example that the question being answered in the response was about how to start a blog post. Therefore, in some embodiments of the method of FIG. 8, at step 688 the second input prompt transmitted to the second generative model 534 is further based on the first input prompt. For example, the second input prompt may include some or all of the first input prompt or may include a summary of the first input prompt or something related to the first input prompt. Such is the case in the example in FIG. 10, which is a variation of FIG. 9 in which the second input prompt 704 includes both text based on the first symbols (“The hallmark of a successful blog post is to start”) and text that is the first input prompt that was sent to the first generative model 532 (“How should I start my blog post?”). Specifically, as shown in FIG. 10 the second input prompt 704 is “Finish the response: How should I start my blog post? The hallmark of a successful blog post is to start”. As a result of this additional information, the second symbols 706 output from the second generative model 534 are more relevant to the exchange. In the example, the second symbols 706 output from the second generative model 534 form the basis of the text “off with a personal story that connects with the reader.” The output shown in bubble 618 is therefore “The hallmark of a successful blog post is to start off with a personal story that connects with the reader.”

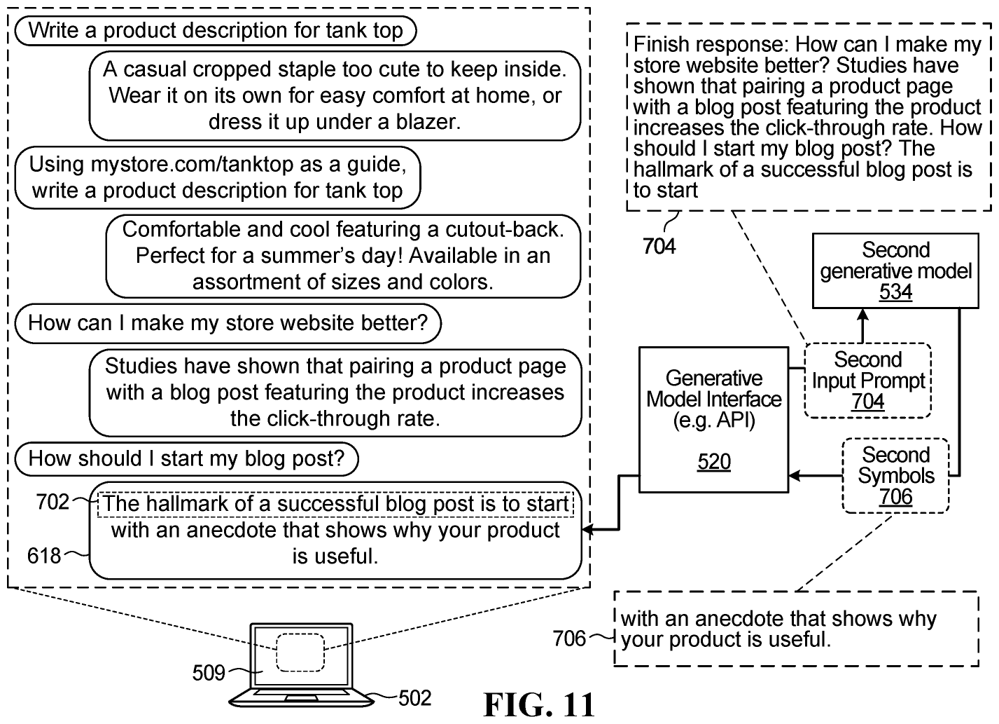

In some embodiments of the method of FIG. 8, at step 688 the second input prompt transmitted to the second generative model 534 may be further based on content corresponding to an exchange between a device (in this case the user device 502) and the first generative model 532 prior to the first input prompt. For example, the second input prompt may include some or all of an earlier exchange between the user and the first generative model 532. An example is shown in FIG. 11, which is a variation of FIG. 10 in which the second input prompt 704 includes part of the previous exchange just prior to the first input prompt. Specifically, in the example in FIG. 11 the second input prompt 704 includes the previous exchange “How can I make my store website better? Studies have shown that pairing a product page with a blog post featuring the product increases the click-through rate.” The full second input prompt 704 in this example is: “Finish response: How can I make my store website better? Studies have shown that pairing a product page with a blog post featuring the product increases the click-through rate. How should I start my blog post? The hallmark of a successful blog post is to start”. With this additional content in the second input prompt, the second symbols 706 output from the second generative model 534 are even more relevant to the exchange, e.g. referring to a product. In the example, the second symbols 706 output from the second generative model 534 form the basis of the text “with an anecdote that shows why your product is useful.” The output shown in bubble 618 is therefore “The hallmark of a successful blog post is to start with an anecdote that shows why your product is useful.”

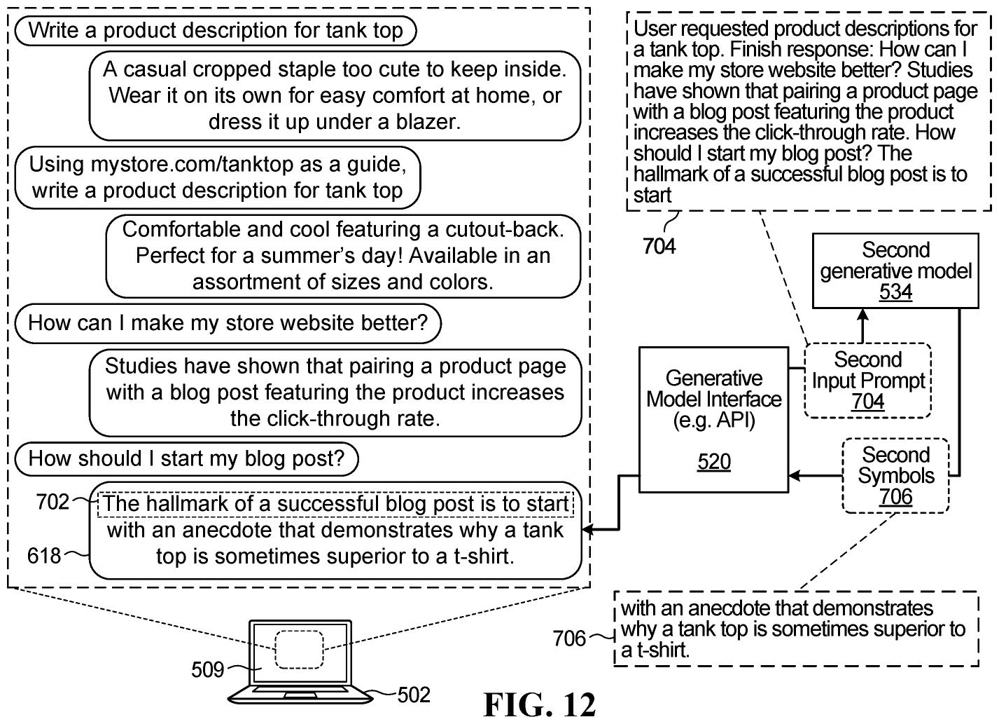

In some embodiments, the content in the second input prompt may provide a summary of an exchange between the user device 502 and the first generative model 532. In some embodiments, the second input prompt may also or instead be based on both the summary of the exchange and input prompts and/or symbols transmitted between the device and the first generative model 532 subsequent to the exchange up until the second input prompt is generated. An example of this is shown in FIG. 12, which is another variation of FIG. 10 in which the second input prompt 704 includes a summary of the earlier exchange relating to generating a product description, summarized in the second input prompt 704 as “User requested product descriptions for a tank top”. The second input prompt 704 then includes the text forming the input prompts and responses subsequent to the summarized exchange up until the second input prompt is generated, which in this example is “How can I make my store website better? Studies have shown that pairing a product page with a blog post featuring the product increases the click-through rate. How should I start my blog post? The hallmark of a successful blog post is to start”. Therefore, in the example in FIG. 12 the full second input prompt 704 is: “User requested product descriptions for a tank top. Finish response: How can I make my store website better? Studies have shown that pairing a product page with a blog post featuring the product increases the click-through rate. How should I start my blog post? The hallmark of a successful blog post is to start”. With this additional content in the second input prompt 704, the second symbols 706 output from the second generative model 534 are even more relevant to the exchange, e.g. referring to a tank top. In the example, the second symbols 706 output from the second generative model 534 form the basis of the text “with an anecdote that demonstrates why a tank top is sometimes superior to a t-shirt.” The output shown in bubble 618 is therefore “The hallmark of a successful blog post is to start with an anecdote that demonstrates why a tank top is sometimes superior to a t-shirt.”

In another variation not illustrated, the second input prompt might include the full exchange with the first generative model 532, e.g. all previous input prompts sent to the first generative model 532 and all responses received from the first generative model 532 up to and including the first symbols received just prior to switching to the second generative model 534. This may be easier than generating and including a summary of an exchange, but it has the drawback of needing to transmit a larger input prompt to the second generative model 534, which requires time and bandwidth. Moreover, a larger input prompt may require more processing resources (computation and/or time) by the second generative model 534 to provide a response. Moreover, a larger input prompt may end up exceeding the prompt length limit of the second generative model 534. Therefore, by instead including in the prompt a summary of an earlier exchange between the device and first generative model 532, like in the example in FIG. 12 in which the summary is “User requested product descriptions for a tank top”, there may be achieved an optimal trade-off between length of input prompt and relevancy of response from the second generative model 534.

Note that in the example input prompt to the second generative model 534 in each of FIGS. 9 to 12 it starts with the instruction “Finish the response: . . . ”. For some generative models it might not be necessary to include this explicit completion directive if the generative model is already built to complete whatever is fed into it.

In embodiments in which the second input prompt includes a summary of an earlier exchange, like in the example of FIG. 12, how and when a summary is generated is implementation specific. In some embodiments, a summary is generated by a generative model, e.g. the first generative model 532 or the second generative model 534 or another generative model. For example, the generative model may be sent an input prompt that says “Summarize the following exchange: Write a product description for tank top. A casual cropped staple too cute to keep inside. Wear it on its own for easy comfort at home, or dress it up under a blazer. Using mystore.com/tanktop as a guide, write a product description for tank top. Comfortable and cool featuring a cutout-back. Perfect for a summer's day! Available in an assortment of sizes and colors.” The generative model may return as a response “User requested product descriptions for a tank top”, which is used as the summary in the FIG. 12 example. In some embodiments, a summary is generated at particular points or checkpoints in time, e.g. every 3 minutes, or after every 1000 symbols generated by the generative model. For example, at the end of each 3-minute window of time a summary is generated for any exchange that happened during that 3-minute window of time. Then, if a switch to the second generative model 534 is needed, the second input prompt may include the most recent summary or some or all of the previous summaries, along with the full exchange subsequent to the duration of time captured by the summary. This may reduce the length of the second input prompt compared to including the whole exchange verbatim. In some embodiments, a summary is generated whenever the exchange switches topics. For example, the summary of the exchange relating to product descriptions for a tank top shown in FIG. 12 may be generated once it is determined that the user has moved to a new topic (asking how to make the store website better). A machine learning model may be used to receive the exchange as input and provide an indication (e.g. a probability) that the exchange has moved on to a different topic. The change in topic may act as a checkpoint at which point a generative model is asked to provide a summary. In some embodiments, the generative model itself may be asked to determine whether there is a change in topic and if so generate a summary. The generative model may be sophisticated enough and/or trained to generate the summary in a smart way, e.g. handle an example prompt such as: “If the exchange has moved to a new topic, then provide a summary of the exchange so far, omitting information that is not pertinent to the new topic”. If the new topic is completely different, the summary may be short, whereas if the new topic is similar to the previous topic the summary may be more detailed.

In view of the above, in some embodiments, the method of FIG. 8 may include providing, to the first generative model 532 or to the second generative model 534 or to a different third generative model, an input prompt comprising at least a portion of an exchange between a device and the first generative model 532, and in response receiving the summary of the exchange. The third generative model may be, for example, a generative model that is optimized for generating summaries. It may be a smaller lightweight model compared to the first generative model 532 and/or the second generative model 534.

In some embodiments, each message in an exchange may be tagged by a topic identifier. The topic identifier may be used to delineate different topics. The second input prompt to the second generative model 534 might include one or more topic identifiers, e.g. as a summary of the exchange or in addition to the summary of the exchange.

In some embodiments of the method of FIG. 8, only a partially-completed response to the first input prompt may have been received from the first generative model 532 when at step 688 the second input prompt is transmitted to the second generative model 534. Such is the case in the example illustrated in FIGS. 4 and 9 to 12. The partially-completed response may be based on the first symbols (e.g. includes the first symbols or is the first symbols or is related to the first symbols). For example, in FIGS. 4 and 9 to 12 the partially-completed response is “The hallmark of a successful blog post is to start”, which is the text corresponding to the first symbols as thus far received from the first generative model 532 at the point of switching and sending the second input prompt 704 to the second generative model 534. In some embodiments, a remaining portion of the response to the first input prompt is based on the second symbols output from the second generative model 534. In some embodiments, providing output based on the first symbols and the second symbols may include: providing, for output on a display of a device, the partially-completed response based on the first symbols; and responsive to receiving at least a portion of the second symbols, providing for output on the display, the remaining portion of the response based on the second symbols. In some embodiments, the remaining portion may be provided for output adjacent to and/or following the partially-completed response. This is the case in the examples in FIGS. 9 to 12. For example, in FIG. 12 the output for display in bubble 618 is “The hallmark of a successful blog post is to start with an anecdote that demonstrates why a tank top is sometimes superior to a t-shirt”. This consists of the partially-completed response based on the first symbols (“The hallmark of a successful blog post is to start”) with the remaining portion of the response based on the second symbols (“with an anecdote that demonstrates why a tank top is sometimes superior to a t-shirt”) output adjacent to and following the partially-completed response. From the perspective of the user, the switch to the second generative model 534 is transparent and seamless. The user does not know that a switch to the second generative model 534 was performed in response to latency in output from the first generative model 532. The user perceives little to no latency, or any latency perceived by the user is just temporary until the switch to the second generative model 534.

As discussed earlier, the first generative model 532 and the second generative model 534 used in the method of FIG. 8 may be the same or different. For example, first generative model 532 and the second generative model 534 may be at least one of: a same model; different instances of the same model (e.g. different hardware and/or software instances); a same architecture; fine-tuned in a same way; or have a same configuration setting. In some embodiments, the first generative model 532 may be hosted by a particular SaaS provider and the second generative model 534 might or might not be hosted by that particular SaaS provider.

In some embodiments of the method of FIG. 8, to try to better ensure that the second generative model 534 generates output that is consistent with what would be output by the first generative model 532, the first input prompt and the second input prompt may include a same configuration setting. For example, the first input prompt and the second input prompt may include a same setting value that controls the length, style, and/or content output from the generative model, e.g. a same temperature value, and/or a same stopping criteria, and/or a same minimum and/or maximum token output, etc. In some embodiments, a seed parameter in an input prompt may control variability of the response, e.g. if the same seed value is used in two different input prompts to a generative model, then if the content of the two different input prompts is the same, then the same output will be generated by the generative model. The same seed value may be used for both the first input prompt transmitted to the first generative model 532 and the second input prompt transmitted to the second generative model 534. The seed value may be considered a configuration setting.

The method of FIG. 8 assumes that there is no latency (or acceptable latency) associated with the output from the second generative model 534. However, in some scenarios there might also be latency associated with the output from the second generative model 534. Therefore, in some embodiments of the method of FIG. 8, sometime prior to transmitting the second input prompt to the second generative model 534, the method may include transmitting a prompt to the second generative model 534 and measuring the latency associated with receiving symbols from the second generative model 534 in response to that prompt. In doing so, the performance (in terms of latency) of the second generative model 534 may be measured. For example, synthetic input prompts may be periodically generated and transmitted to the second generative model 534, and the latency associated with the responses to those prompts measured. Alternatively, the computing system 514 may monitor the latency in responses to real input prompts sent to the second generative model 534 by or on behalf of other users. In some embodiments, a switch from the first generative model 532 to the second generative model 534 might only occur if the latency performance of the second generative model 534 is better than the first generative model 532. In some embodiments, there may be a limit on the number of switches between generative models that can be performed, e.g. if a switch is made to the second generative model 534 and it is also having latency issues, then do not switch again to another generative model because it is likely having latency issues also.

In some embodiments of the method of FIG. 8, once a decision is made to switch to the second generative model 534 at step 688, the continued response from the first generative model 532 (after the switch point) may still be received by the computing system 514, but not output for display. Then, if the latency associated with the first generative model 532 recovers before symbols are received from the second generative model 534, the second generative model 534 may be abandoned. Alternatively, even if the second generative model 534 has started providing its response, it may be possible to fallback to the first generative model 532 if the output from the second generative model 534 has latency that is worse than the output from the first generative model 532. That is, it may be possible to backtrack to the first generative model 532. Therefore, in some embodiments, the method of FIG. 8 may further include: subsequent to transmitting the second input prompt to the second generative model 534, receiving additional symbols from the first generative model 532, where the additional symbols are received subsequent to the first symbols but still responsive to the first input prompt. The method may further include storing the additional symbols in memory. The method may further include outputting at least some of those additional symbols for display instead of at least some of the second symbols. This may involve deleting some of the output based on the second symbols and replacing it with the output based on the additional symbols.

Technical benefits of the method of FIG. 8 may include the following. Latency in a response from a generative model may be mitigated or eliminated by switching from that generative model to a second generative model in response to detecting the latency. This avoids wasting time and/or computer resources associated with waiting for the delayed symbols or restarting the generation process. For example, the input prompt does not need to be resent to the first generative model 532 to restart the generation process if the response is too latent and/or times out. A generative model is a precious computing resource, and so in many situations there is a limit (e.g. on the computing system 514 and/or on the user device 502) limiting use of a generative model. For example, the limit may be a token limit and/or a limit on how many prompts can be sent to the generative model. The restarting of the generation process, such as by resending the input prompt, uses up the valuable limited resource. By avoiding the restarting of the generation process, the computational resources of the generative model are not wasted. This also provides a benefit in the machine-user interaction. The latency can be addressed before the user is substantially impacted by it, and a situation of the response timing out and needing to be restarted is avoided, which also avoids confusion for the user. Instead, the user seamlessly and transparently receives generative model output, not even knowing or realizing that the switch from the first generative model 532 to the second generative model 534 occurred. Moreover, because the second input prompt sent to the second generative model 534 is based on at least some of the first symbols received from the first generative model 532, the response generated by the second generative model 534 will be more coherent and consistent with the exchange, thereby mitigating the possibility of an inconsistent response or a “hallucination” being generated by the second generative model 534. In embodiments in which a summary of an exchange between the device and first generative model 532 is included in the second input prompt (e.g. like in the example in FIG. 12 where the summary is “User requested product descriptions for a tank top”), a further technical benefit is realized in that the second input prompt is limited in length, which allows for faster processing of the second generative model 534 (and fewer processing operations of the second generative model 534) and also stays within prompt length limits, but the second input prompt still conveys a lot of relevant information that allows for the second generative model 534 to provide a response that is even more relevant, coherent, and consistent with the exchange, thereby further mitigating the possibility of an inconsistent response or a “hallucination” being generated by the second generative model 534.

Some further variations of the method of FIG. 8 will now be discussed.

The method of FIG. 8 is explained as being performed by computing system 514 of FIG. 3. For example, the computing system 514 has an interface 520, e.g. comprising one or more APIs, which are used to send prompts to and receive responses from generative models. The computing system 514 determines if there is latency in output from a generative model and performs a switch in the manner explained in relation to FIG. 8. Alternatively, the method of FIG. 8 may be performed by the user device 502, e.g. if the user device 502 is configured with code or an application that is executed by the processor 504 to cause the user device 502 to perform the method. By performing method on user device 502, the user device 502 can take into account any and all latency between a generative model and the user device, e.g. latency in network 512 if that network exists. As explained earlier, in some embodiments the computing system 514 might not even exist or the user device 502 and computing system 514 may be or act as a single device, in which case the user device 502 performs the method of FIG. 8. In another variation, it might be the case that the user device 502 of FIG. 3 does not exist, e.g. a computer system (such as computing system 514) is accessing a generative model and processing outputs without necessarily presentation to a user. The method of FIG. 8 would still apply.

The method of FIG. 8 equally applies if the latency associated with receiving the first symbols from the first generative model 532 is because the first generative model 532 fails or stops providing output, e.g. because it crashes, errors out, or hits a token limit. In this situation the measured latency in step 686 would fall within a range triggering a switch (in step 688) to the second generative model 534. The technical benefits described above would still apply, e.g. the switch avoids wasting time and/or computer resources associated with trying to restart the generation process, and the situation can be addressed before the user is substantially impacted by it.

In the method of FIG. 8 and related FIG. 3 there are two generative models 532 and 534. In general, there may be more than two generative models, and switching might occur amongst the generative models. For example, the end of method FIG. 8 may include further steps of determining latency in symbols output from the second generative model 534 and in response switching to a third generative model, in which case the input prompt to the third generative model may be based on some of the previous exchange (e.g. based on symbols output from the second generative model 534). In some embodiments, there may be a cap or limit on how often switching between generative models can occur. This may avoid continual pointless switching between different generative models in situations where all generative models have bad latency, e.g. because of an issue impacting the network as a whole or all generative models. In some embodiments, if there are multiple different generative models to which the system may switch, then a generative model may be selected that is as close to the current generative model being used, e.g. in terms of same type or architecture or class of model.

The example shown in FIGS. 4 to 7 and 9 to 12 assumes that the first generative model 532 is a first generative language model (e.g. first LLM) and that the second generative model 534 is a second generative language model (e.g. second LLM). An LLM is an example of a generative language model, and whenever “LLM” is used herein it is only an example and may be replaced with “generative language model”. Even though the examples shown in FIGS. 4 to 7 and 9 to 12 assume generative language models, the method of FIG. 8 is not limited to generative language models. For example, the first generative model 532 and the second generative model 534 may generate images. The symbols output from the first generative model 532 may be or represent pixels of an image. The image may begin to be output on the display of the user device 502, but due to latency not all pixels are timely received (or possibly not received at all) and the image appears blurry. In response, the switch is made to the second generative model 534 in step 688, and the second generative model 534 provides the remainder of the image pixels.

The example shown in FIGS. 4 to 7 and 9 to 12 assumes that the switch from the first generative model 532 to the second generative model 534 in step 688 of FIG. 8 occurs mid-response, i.e. the first symbols output from the first generative model 532 only provide a partially-completed response to the first input prompt. However, FIG. 8 is not limited to this scenario. The switch might instead occur, for example, once the response from the first generative model 532 is fully received. For example, assume the scenario in FIG. 7 where the first generative model 532 is providing the response, but there is latency. The latency may be tolerable and the computing system 514 may therefore just wait and receive the whole response to the first input prompt from the first generative model 532. Then, once outputting that response, if a subsequent input prompt is received from user device 502, the computing system 514 may instead send that subsequent input prompt to the second generative model 534.

As discussed above, in some embodiments an API may be used to interface with one or more generative models, e.g. the generative model interface 520 may be or include an API. In some embodiments, the conventional API is modified and improved to provide the functionality of FIG. 8. For example, the API may be configured to allow for an API call that can distinguish a user input prompt (e.g. “How should I start my blog post?”) from a prompt that is originating from the system (e.g. chat assistant) itself and that relates to continuing the response. For example, the role (user or system) associated with the API call may need to be specified in a field of the call, particularly if the API call is an instruction to continue the response (i.e. the “second input prompt” in FIG. 8 is an API call that is an instruction to continue the response).

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
transmitting a first input prompt to a first generative model;
receiving first symbols output from the first generative model responsive to the first input prompt;
measuring a latency associated with receiving the first symbols from the first generative model;
responsive to the latency being within a particular range, transmitting a second input prompt to a second generative model, the second input prompt based on at least some of the first symbols received from the first generative model;
receiving second symbols output from the second generative model responsive to the second input prompt; and
providing output based on the first symbols and the second symbols.

2. The computer-implemented method of claim 1, wherein the first generative model is a first large language model (LLM), and the second generative model is a second LLM.

3. The computer-implemented method of claim 1, wherein only a partially-completed response to the first input prompt has been received from the first generative model when the second input prompt is transmitted to the second generative model, the partially-completed response based on the first symbols, and wherein a remaining portion of the response to the first input prompt is based on the second symbols output from the second generative model.

4. The computer-implemented method of claim 3, wherein providing output based on the first symbols and the second symbols comprises:
providing, for output on a display of a device, the partially-completed response based on the first symbols; and
responsive to receiving at least a portion of the second symbols, providing for output on the display, the remaining portion of the response based on the second symbols, the remaining portion provided for output adjacent to and following the partially-completed response.

5. The computer-implemented method of claim 1, wherein the latency is measured based on an amount of time to receive a symbol.

6. The computer-implemented method of claim 5, wherein measuring the latency comprises measuring at least one of:
symbols received per unit of time;
time taken to receive the first symbols;
time to receive a symbol; or
time to first symbol.

7. The computer-implemented method of claim 1, wherein the second input prompt is further based on the first input prompt.

8. The computer-implemented method of claim 7, wherein the second input prompt is further based on content corresponding to an exchange between a device and the first generative model prior to the first input prompt.

9. The computer-implemented method of claim 8, wherein the content provides a summary of the exchange.

10. The computer-implemented method of claim 9, wherein the second input prompt is based on both the summary of the exchange and input prompts and symbols transmitted between the device and the first generative model subsequent to the exchange up until the second input prompt is generated.

11. The computer-implemented method of claim 1, wherein the first generative model and the second generative model are at least one of:
a same model;
different instances of the same model;
a same architecture;
fine-tuned in a same way; or
have a same configuration setting.

12. The computer-implemented method of claim 1, wherein the first generative model is hosted by a particular software-as-a-service (SaaS) provider and the second generative model is not hosted by the particular SaaS provider.

13. The computer-implemented method of claim 1, wherein prior to transmitting the second input prompt to the second generative model, the method further comprises transmitting a prompt to the second generative model and measuring the latency associated with receiving symbols from the second generative model in response to the prompt.

14. A system comprising:
at least one processor; and
a memory storing processor-executable instructions that, when executed, cause the at least one processor to:
transmit a first input prompt to a first generative model;
receive first symbols output from the first generative model responsive to the first input prompt;
measure a latency associated with receiving the first symbols from the first generative model;
responsive to the latency being within a particular range, transmit a second input prompt to a second generative model, the second input prompt based on at least some of the first symbols received from the first generative model;
receive second symbols output from the second generative model responsive to the second input prompt; and
provide output based on the first symbols and the second symbols.

15. The system of claim 14, wherein only a partially-completed response to the first input prompt has been received from the first generative model when the second input prompt is transmitted to the second generative model, the partially-completed response based on the first symbols, and wherein a remaining portion of the response to the first input prompt is based on the second symbols output from the second generative model.

16. The system of claim 15, wherein the at least one processor is to provide the output based on the first symbols and the second symbols by performing operations comprising:
providing, for output on a display of a device, the partially-completed response based on the first symbols; and
responsive to receiving at least a portion of the second symbols, providing for output on the display, the remaining portion of the response based on the second symbols, the remaining portion provided for output adjacent to and following the partially-completed response.

17. The system of claim 14, wherein the latency is measured based on an amount of time to receive a symbol.

18. The system of claim 14, wherein the second input prompt is further based on the first input prompt.

19. The system of claim 14, wherein the first generative model and the second generative model are at least one of:
a same model;
different instances of the same model;
a same architecture;
fine-tuned in a same way; or
have a same configuration setting.

20. A non-transitory computer readable medium having stored thereon computer-executable instructions that, when executed by a computer, cause the computer to perform operations comprising:
transmitting a first input prompt to a first generative model;
receiving first symbols output from the first generative model responsive to the first input prompt;
measuring a latency associated with receiving the first symbols from the first generative model;
responsive to the latency being within a particular range, transmitting a second input prompt to a second generative model, the second input prompt based on at least some of the first symbols received from the first generative model;
receiving second symbols output from the second generative model responsive to the second input prompt; and
providing output based on the first symbols and the second symbols.
